(19) United States
(12) Patent Application Publication
(10) Pub. No.: US 2012/0260885 A1
(43) Pub. Date: Oct. 18, 2012

(54) Water lubricated composite piston engine

(76) Inventor: James W. Linck, Metairie, LA (US)

(21) Appl. No.: 13/066,535

(22) Filed: Apr. 18, 2011

(51) Int. Cl. F02B 77/00

(52) U.S. Cl. 123/197.4; 123/193.6

(57) ABSTRACT

A water lubricated and cooled composite piston engine is fitted with a carbon composite crankshaft, rod, block, and flywheel, it is also fitted with a carbon carbon piston, a conventional head or composite or carbon carbon head. A water lubricated engine has been developed by Mercedes for drilling rigs in the North Sea now making this application possible.

### GOVERNMENT INTERESTS

None

U.S. Patent Documents

| | | |
|---|---|---|
| 3,890,950 | June 1975 | Haldeman |
| 3,890,950 | September 1985 | Harris |
| 4,644,911 | February 1987 | Hidaka et al. |
| 4,683,809 | August 1987 | Tayor |
| 4,726,334 | February 1988 | Holtzberg |
| 4,909,133 | March 1990 | Taylor et al. |
| 5,687,634 | November 1997 | Ransome |
| 5,769,046 | June 1998 | Ransome |
| 6,044,819 | April 2000 | Rivers et al. |

### PARENT CASE TEST

None

### BACKGROUND OF THE INVENTION

1. Field of the Invention

The invention relates to an internal combustion piston engine that is constructed with carbon composite moving parts such as the crankshaft, connecting rod and flywheel, a carbon carbon piston, and a lubrication system that is water based.

2. Description of the Related Art

Internal combustion engines are now over a hundred and twenty five years old and have gone through development from cast iron blocks to aluminum blocks, but their crankshafts, rods, and flywheel remain steel. The piston remains alumimum and their lubrication medium remains oil based.

### SUMMARY OF THE INVENTION

Carbon composites and carbon carbon have many advantages over conventional structural materials. The main advantage is their strength to weight ratio and their stiffness to weight ratio making them the core material from many products such as aircraft, missiles, race cars, skies, bikes, tennis racquets, etc. Another advantage is they do not expand like metals when heated making the ideal for the tight fit of components in engines. A disadvantage of composites is their heat limit when compared to metals.

The heat limit is 150 degrees F. for carbon composites. The internal core of conventional oil lubricated piston engines remains in the 200 degrees F. range and above making conventional carbon composites unable to survive in this atmosphere in a normal engine.

Accordingly an object of this invention is to use a water based lubrication system to keep the core of the engine below 150 degree F. making the use of carbon composites possible. Water has about twice the heat capacity as oil. This means one quart of water will carry away twice the heat as one quart of oil.

It is another object of the present invention to utilize the weight saving advantages of carbon carbon in the piston to lower the overall weight of the crankshaft balance weight.

It is another object of the present invention to utilize carbon composites throughout the motor to lighten the engine. Every pound of engine saved in a car is four to five pounds of weight saved in the chassis.

### BRIEF DESCRIPTION OF THE DRAWINGS

FIG. 1 is an illustration of a single cylinder composite piston engine showing the carbon carbon piston, the carbon composite crankshaft, rod, block and head.

### DETAILED DESCRIPTION OF THE INVENTION

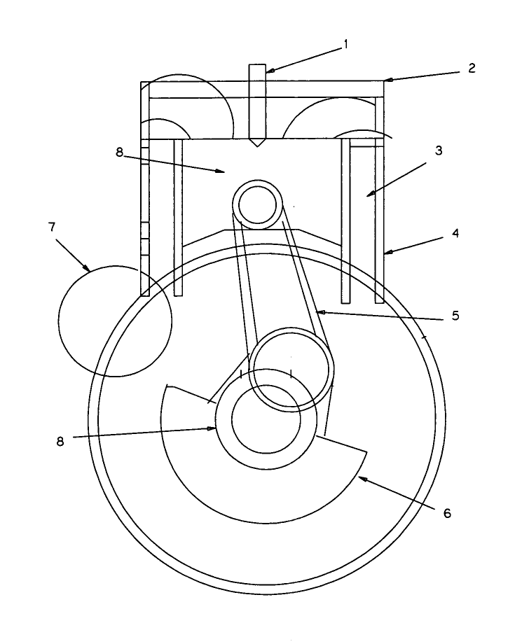

FIG. 1 is an illustration of a single cylinder composite piston engine. Part number 1 is the spark plug or injector depending on type of engine. Part number 2 is the cylinder head which is bolted to the block and is conventional. Part number 3 is the water jacket surrounding the cylinder. Part number 4 is the carbon composite block of the engine and contains all the parts of the engine. Part number 5 is the carbon connecting rod which connects the piston and the crankshaft. Part number 6 is the carbon connecting rod which transmits the pressure from the piston to the clutch or drive shaft of the engine. Part number 7 is the water pump which lubricates and cools the engine. Part number 8 is the carbon carbon piston which transmits pressure from combustion in the cylinder to the connecting rod. Part number 9 is a seal around the bearings which controls the bearing film lubricating and cooling the bearings.

The invention descripted here is basic in nature to show the application of the carbon composites and carbon carbon parts to any internal combustion piston engine.

What is claimed is:

1. In the construction of an internal combustion piston engine the cylinder block, connecting rod, crankshaft, and flywheel are constructed from carbon reinforced composite material.

2. In the construction of an internal combustion piston engine the piston is constructed from carbon carbon material.

3. In the construction of the composite internal combustion piston engine the lubrication fluid is water based with additional additives.
